(19) United States
(12) Patent Application Publication
(10) Pub. No.: US 2009/0307705 A1
(43) Pub. Date: Dec. 10, 2009

(54) SECURE MULTI-PURPOSE COMPUTING CLIENT

(75) Inventor: Etay Bogner, Tel Aviv (IL)

Correspondence Address: D. Kligler I.P. Services LTD, P.O. Box 25, Zippori, 17910, IL

(73) Assignee: NEOCLEUS ISRAEL LTD, Tel Aviv (IL)

(21) Appl. No.: 12/477,167

(22) Filed: Jun. 3, 2009

Related U.S. Application Data
(60) Provisional application No. 61/131,354, filed on Jun. 5, 2008.

(51) Int. Cl. G06F 9/46; G06F 15/16; G06F 15/173

(52) U.S. Cl. 718/104; 726/15; 709/223; 709/217; 709/203

(57) ABSTRACT

A method includes, in a computer that runs multiple operating environments using hardware resources, defining and managing an allocation policy of the hardware resources, which eliminates effects from operations performed in one of the operating environments on the operations performed in another of the operating environments. The hardware resources are assigned to the multiple operating environments in accordance with the allocation policy, so as to isolate the multiple operating environments from one another.

### CROSS-REFERENCE TO RELATED APPLICATIONS

This application claims the benefit of U.S. Provisional Patent Application 61/131,354, filed Jun. 5, 2008, whose disclosure is incorporated herein by reference.

### FIELD OF THE INVENTION

The present invention relates generally to computer applications, and particularly to schemes for running multiple operating environments on a local and/or remote computer.

### BACKGROUND OF THE INVENTION

Various applications allow users to interact with a computer system, e.g., a data center, over the Internet or other network. Applications of this sort enable users, for example, to carry out financial transactions with organizations such as banks or insurance companies and make purchases using electronic commerce (e-commerce) web-sites. Employees can access organization data remotely over the Internet, and physicians can access medical records maintained by health institution database systems. Other applications allow users to access various Internet resources, such as games, electronic mail (e-mail) and many others. Some applications execute locally on the user computer.

Various methods and systems for securing network applications are known in the art. For example, U.S. Patent Application Publications 2008/0040470 and 2008/0040478, whose disclosures are incorporated herein by reference, describe methods and systems for extranet security. In these schemes, a user computer runs first and second operating environments. The first operating environment is arranged to perform general-purpose operations. The second operating environment is configured expressly for interacting with a certain server in a communication session and is isolated from the first operating environment. A central management subsystem, which is external to the server and to the user computer, monitors the operation of the second operating environment running on the user computer and controls the communication session based on the monitored operation.

Interaction of a user computer with a computer system typically involves running a client program (typically referred to simply as a client) in the user computer. In some applications, the software and desktop used by the user are hosted by a remote computer system, and the user computer runs only a limited-functionality client. These applications are commonly referred to as desktop virtualization or Virtual Desktop Infrastructure (VDI).

### SUMMARY OF THE INVENTION

An embodiment of the present invention provides a method, including:

in a computer that runs multiple operating environments using hardware resources, defining and managing an allocation policy of the hardware resources, which eliminates effects from operations performed in one of the operating environments on the operations performed in another of the operating environments; and

assigning the hardware resources to the multiple operating environments in accordance with the allocation policy, so as to isolate the multiple operating environments from one another.

In some embodiments, the method includes running in one or more of the operating environments respective client programs for communicating with remote servers. In an embodiment, running the client programs includes performing data processing functions locally in the computer by at least one of the client programs. Performing the data processing functions may include performing multimedia processing functions locally in the computer. Performing the multimedia processing functions may include performing Voice over Internet Protocol (VoIP) processing and/or video streaming processing. In some embodiments, running the client programs includes performing Virtual Private Network (VPN) processing functions, security functions and/or Internet browsing functions locally in the computer by at least one of the client programs.

In a disclosed embodiment, the method includes running in one or more of the operating environments respective applications that execute locally in the computer. Additionally or alternatively, the method may include running in one or more of the operating environments respective software appliances, each running a respective single-purpose application. In an embodiment, the method includes communicating with a management system external to the computer, so as to enable the management system to apply authentication testing to the computer.

In another embodiment, assigning the hardware resources includes enforcing a predefined isolation policy on the operating environments. Enforcing the isolation policy may include dividing the operating environments into groups, and allowing interaction among the operating environments only within each of the groups. In an embodiment, the isolation policy defines allowed sharing of data among the operating environments within each of the groups.

In some embodiments, the method includes provisioning a set of the operating environments for use by a given user responsively to a predefined profile of the given user. Provisioning the operating environments may include retrieving one or more of the operating environments in the set over a network. In an embodiment, at least one of the operating environments in the set includes a software appliance, which runs a single-purpose application. In a disclosed embodiment, provisioning the operating environments includes authenticating the given user and provisioning the operating environments responsively to successful authentication.

In some embodiments, the method includes merging respective Graphical User Interfaces (GUIs) of two or more of the operating environments to produce a unified GUI, and presenting the unified GUI to a user of the computer. The hardware resources may include processor resources, memory resources, network interface resources and/or peripheral devices.

There is additionally provided, in accordance with an embodiment of the present invention, a computer, including:

a memory, which is operative to store software code; and

a processor, which is configured to execute the software code so as to run multiple operating environments using hardware resources of the computer, to define and manage an allocation policy of the hardware resources, which eliminates effects from operations performed in one of the operating environments on the operations performed in another of the operating environments, and to assign the hardware resources to the multiple operating environments in accordance with the allocation policy, so as to isolate the multiple operating environments from one another.

There is also provided, in accordance with an embodiment of the present invention, a computer software product for operating a computer that includes hardware resources and runs multiple operating environments using the hardware resources, the product including a computer-readable medium, in which program instructions are stored, which instructions, when read by a processor, cause the processor to define and manage an allocation policy of the hardware resources, which eliminates effects from operations performed in one of the operating environments on the operations performed in another of the operating environments, and to assign the hardware resources to the multiple operating environments in accordance with the allocation policy, so as to isolate the multiple operating environments from one another.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system, in accordance with an embodiment of the present invention;

FIG. 2 is a diagram that schematically illustrates an isolation policy enforced by a virtualization layer, in accordance with an embodiment of the present invention; and

FIG. 3 is a flow chart that schematically illustrates a method for operating a user computer, in accordance with an embodiment of the present invention.

### DETAILED DESCRIPTION OF EMBODIMENTS

### Overview

When operating a computer, it is sometimes desirable to maintain isolation between multiple applications that may run concurrently. For example, a certain personal computer may be used by an individual for both work-related and personal activities. As another example, a computer may run different software clients for interacting with different servers (e.g., web-sites, data centers or databases). These activities and applications may run locally in the computer, or remotely (e.g., hosted on a remote data center and run using Virtual Desktop Infrastructure—VDI).

Isolation between such applications in the computer is important for several reasons. For example, running an application in an isolated manner often simplifies the task of detecting viruses and other security threats. From a systems administration perspective, it is considerably simpler to configure and manage an application, or an entire computing environment, in such a way that it is unaffected by other applications running on the same computer. These considerations are particularly significant in systems having large numbers of user computers, such as in large enterprise systems. From the end-user's perspective, it is sometimes advantageous to present to the end-user a unified presentation layer, which comprises both local and remote applications that actually run in multiple separate and isolated computing environments.

Embodiments of the present invention that are described hereinbelow provide methods and systems for running multiple applications on a computer in an isolated manner, i.e., such that operations performed in one application are not affected by operations performed in other applications. As will be explained below, such applications may comprise local applications that run locally on the computer and/or software clients that interact with remote servers.

In some embodiments, a user computer runs multiple different Operating Environments (OEs). The user computer comprises a virtualization unit, which allocates the computer's hardware resources to the different OEs and manages the allocated resources according to a certain allocation policy. The virtualization unit selects the amounts of resources for allocation to each OE such that the applications running in different OEs are isolated from one another. In some embodiments, the virtualization unit enforces a predefined isolation policy, which defines groups of OEs that are allowed to interact with one another. In some embodiments, the virtualization unit is also responsible for management and configuration of the entire user computer. For example, the virtualization unit may fetch OEs from central storage and provision them on the fly.

In some embodiments, at least some of the OEs run respective software clients that communicate with respective remote servers. Some clients may comprise thin clients, in which case the application is hosted by the server. Other clients may comprise fat clients, which are richer in local functionality and processing complexity. When using the methods and systems described herein, a given user computer may communicate with multiple data centers in a mutually-isolated manner. For example, a user may use his computer for checking his personal e-mail, while simultaneously using his company's data center (and possibly an entire remote desktop), without any interaction between the respective clients. The software client that interacts with the company's data center can be tested, configured, upgraded or otherwise maintained without being affected by other activities occurring in the computer.

In some embodiments, the virtualization unit communicates with a Central Management System (CMS), which tests the integrity and trustworthiness of the virtualization unit and/or the OEs. Since the OEs are isolated from one another, their configurations and behaviors are usually known and predictable. As such, the CMS can easily detect an OE (e.g., a certain software client) that is corrupted or tampered with.

The methods and systems described herein increase the security of computing systems, and simplify the management and administration of user computers. For example, enterprises may use the disclosed techniques to deploy clients that are rich in local functionality (e.g., multimedia capabilities) without compromising security and maintenance capabilities. The disclosed techniques enable a user computer to run high-functionality fat clients at a security level and cost-of-ownership that are comparable with those of server-hosted applications and thin clients.

### System Description

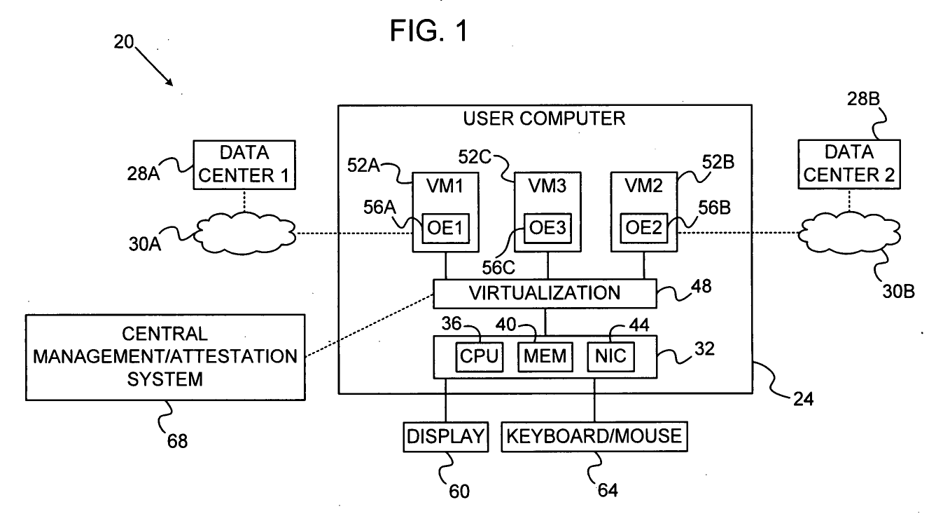

FIG. 1 is a block diagram that schematically illustrates a computing system 20, in accordance with an embodiment of the present invention. System 20 comprises a user computer 24, which is used by a user for communicating with two data centers 28A and 28B, as well as for running one or more local applications. For example, one data center may comprise a computer system of the user's employer, whereas the other data center may comprise an electronic mail (e-mail) server via which the user exchanges personal e-mail messages. Interaction with multiple data centers may occur simultaneously, e.g., when a user checks his personal e-mail during working hours. The data centers typically comprise one or more servers, and may run any suitable type of application, such as web-based applications, database access applications, Microsoft® Windows® applications and many others.

Computer 24 communicates with data centers 28A and 28B via communication networks 30A and 30B, respectively. The networks may comprise any suitable network type, such as wide-area (e.g., the Internet), metropolitan-area or local-area networks. Although in FIG. 1 computer 24 communicates with the different data centers via different networks, communication with the different data centers may alternatively be performed over the same network. In some embodiments, user computer 24 may communicate with a given data center using a Virtual Private Network (VPN).

Computer 24 may comprise any suitable type of computer, such as a desktop computer, a laptop or other mobile computer, a Personal Digital Assistant (PDA), a wireless communication terminal (e.g., cellular phone) having computing capabilities, or any other suitable computing platform. Computer 24 comprises various hardware resources 32, such as one or more Central Processing Units (CPU) 36, memory devices 40, Network Interface Cards (NICs) 44 and/or any other suitable hardware resource. For example, peripheral devices such as Universal serial Bus (USB) devices are also regarded herein as hardware resources. Memory devices 40 may be used, for example, for storing data and software code, such as the software code for carrying out the methods described herein. Memory devices 40 may comprise, for example, solid-state memory such as Random Access Memory (RAM) or non-volatile memory devices, and/or Hard Disk Drives (HDD). The user computer further comprises output devices such as a display 60, and input devices 64 such as a mouse or a keyboard.

In some cases, it is desirable to isolate the applications in computer 24 (e.g., applications that interact with the different data centers and/or local applications), so that the operation of one application will not be affected by another application. This sort of isolation is beneficial for both management/administration and data security reasons. Consider, for example, an organization that allows its employees to access the organization's data center using their personal desktop or laptop computers. The organization may install on the user computers dedicated software clients for this purpose. Each user computer may run, in addition to the organization's client, various other applications that are not under control of the organization. As can be appreciated, it is extremely difficult to manage, troubleshoot or control the organization software clients on the user computers in this environment. If, on the other hand, the operation of the organization software client is isolated from other applications in the user computer, its configuration and performance are typically constant and predictable, and conflicts with other software running on the computer are eliminated. Management of an isolated software client is therefore considerably simpler.

Other benefits of isolation are in the field of data security. Consider, for example, a software client that communicates with a certain data center. This client may be corrupted by various security threats, such as viruses, worms, phishing attacks, keystroke loggers and many others. If the operation of the client is isolated from other applications in the computer, its configuration and performance are usually known and predictable. As such, it is considerably simpler for a security application to detect corruption of the client (e.g., by detecting a deviation from the normal behavior or configuration of the client). Detection of data leakage from a certain application is also simpler to detect or prevent if the application is isolated from other applications.

In computer 24, isolation between applications is carried out by a virtualization layer 48, which controls hardware resources 32 of the computer and allocates them to the applications. Resources that can be allocated by the virtualization layer comprise, for example, resources of CPU 36, memory 40, NIC 44, and/or any other suitable resource type such as peripheral devices.

Computer 24 runs multiple Virtual Machines (VMs), each VM running a respective Operating Environment (OE) that carries out a certain application. Virtualization layer 48 allocates hardware resources to the different VMs, so as to isolate them from one another. Typically, the virtualization layer defines and manages an allocation policy, which assigns hardware resources to the VMs so as to ensure proper isolation. For example, the virtualization layer may allow one VM access to a certain hardware resource, while hiding this resource from another VM.

The virtualization layer may allocate hardware resources to VMs at any desired stage, e.g., a-priori when a VM is provisioned or during VM operation. Once allocated, the virtualization may modify the resource allocation at any stage, as desired. Thus, in the context of the present patent application and in the claims, the term “resource allocation” is used to describe any action that allocates, re-allocates and/or de-allocates hardware resources to VMs.

Virtualization layer 48 may enforce isolation using resource allocation in various ways. For example, layer 48 may allocate separate networks resources so that different VMs access different networks. In some embodiments, layer 48 may assign different NICs to different VMs. Alternatively, layer 48 may assign separate network resources to different VMs over the same NIC, e.g., by assigning different Virtual Local Area Networks (VLANs) or Virtual Private Networks (VPNs) to different VMs, managing different networks on a certain Network Information Service (NIS), or using Network Address Translation (NAT).

As another example, layer 48 may assign separate and isolated memory resources (e.g., RAM, disk partitions and memory storage areas) to different VMs. Graphics resources can also be allocated in a secure and isolated manner to different VMs. For example, Layer 48 may fully switch (e.g., by allocating and re-allocating resources) the computer graphics between different VMs, such that only a given VM has access to the computer's graphics resources at any given time. As yet another example, layer 48 may assign input device resources (e.g., keyboard and/or mouse) to VMs in an isolated manner. Peripheral devices, e.g., Universal Serial Bus (USB) and/or Firewire devices, can also be assigned to specific VMs. As will be explained in detail below, the virtualization layer typically allocates these hardware resources to the VMs according to a certain security policy. (It may be possible in principle to share graphics resources securely between VMs by providing virtualized graphics resources. This sort of solution, however, typically has poor performance and relies heavily on graphics driver support.)

In the example of FIG. 1, computer 24 runs three VMs 52A . . . 52C, which run three OEs 56A . . . 56C, respectively. OE 56A handles runs a software client that communicates with data center 28A, whereas OE 56B handles runs another software client that communicates with data center 28B. The two VMs, and therefore the two clients, are isolated from one another. OE 56C runs a local application, i.e., an application that executes locally and not remotely with the VDI solution. VM 52C, which runs the local application, is isolated from the other two VMs running in computer 24.

From the end-user's perspective, however, all three VMs are presented locally, and the end-user is typically unaware of the real execution environment. (Note, however, that this sort of unified presentation is in no way mandatory. For example, in some embodiments the virtualization layer performs full graphics switching between VMs, regardless of whether the applications in questions execute locally or remotely.) In the description above, the locally-executed environment is responsible for the graphics resources and provides access to some presentation capabilities to the other VMs. Thus, the locally-executed application enjoys the full capabilities of the local hardware, whereas the remotely-executed application is merely remotely “projected.”

The description above refers to a VM as a software entity that runs an OE. Sometimes, however, the terms VM and OE may be used herein interchangeably. Typically, a given OE comprises an Operating System (OS) and a productivity application, and may also comprise additional applications, such as anti-virus, anti-malware or other security application, management applications, etc. Other VMs may be set-up for executing a single-purpose application, such as an Anti-Virus program, which runs solely within this particular VM. This sort of AV program is able to protect all local VMs with a single AV instance (instead of running multiple instances, one in each local VM). This sort of application is often referred to as a “software appliance” and is usually not a general-purpose, user accessible application.

Virtualization layer 48 may comprise any suitable type of virtualization means, such as a hypervisor, as is known in the art. In an example embodiment, layer 48 comprises a type-1 hypervisor, also known as a “bare-metal” hypervisor. Virtualization layer 48 may be implemented in hardware, in software or using a combination of hardware and software elements. Either software-based or hardware-based isolation can be used. Typically, the virtualization layer runs directly above the computer hardware and is not accessible to users. As such, the virtualization layer is not susceptible to viruses and other security threats.

In some embodiments, virtualization layer 48 verifies the trustworthiness of the OEs, and attempts to detect security threats that may have corrupted them. For example, since the virtualization layer controls access to the computer's hardware resources, it can pause the operation of a given OE, and then perform a test that verifies the OE state and/or data before resuming operation.

In some embodiments, the trustworthiness of virtualization layer 48 is assessed by a Central Management System (CMS) 68, which is external to the user computer. The CMS may assess the trustworthiness of layer 48 in any suitable way, such as by running various kinds of tests on layer 48 and/or requesting layer 48 to provide certain portions of its code and verifying their integrity. In some embodiments, CMS 68 also verifies the trustworthiness of OEs 56A and 56B. Further aspects related to the operation of CMS 68 and virtualization layer 48 are addressed in U.S. Patent Application Publications 2008/0040470 and 2008/0040478, cited above.

In some embodiments, the virtualization layer applies trusted computing services, as are known in the art, for verifying the integrity of the user computer. Trusted computing services can be implemented, for example, using a Trusted Platform Module (TPM) installed in the user computer.

The software clients run by the different OEs in computer 24 may have different levels of functionality. For example, a given data center may operate using thin clients. In this sort of operation, the major components of the OE (e.g., operating system and productivity application) are hosted in the data center. A thin client typically transfers the desktop to be displayed to the user from the data center to the user computer, and transfers keyboard keystrokes and mouse movements from the user computer to the data center. Thin client operation simplifies the client-side software and reduces the associated operation costs, but on the other hand limits the computational complexity and the graphical and multimedia capabilities that can be used on the client side.

Other data centers may operate using higher-functionality clients in the user computers, sometimes referred to as fat clients. In this sort of operation, the operating system and productivity application typically run in the user computer, i.e., are part of the software client. In other words, the client performs some kind of data processing (which may involve, for example, graphics and/or computational functions) locally in the user computer, other than merely relaying the video, keyboard or mouse operations. Fat clients have the advantage of enabling higher performance on the client side, at the cost of higher complexity.

Local multimedia capabilities that can be supported by fat clients may comprise, for example, Voice over Internet Protocol (VoIP) and/or video streaming and sound. Other kinds of local data processing operations that can be performed locally by fat clients may comprise, for example, security functions (e.g., Anti Virus (AV) or firewall functions), general-purpose Internet browsing and/or backup functions. In some cases, a certain OE is required to run locally on the user computer in order to comply with regulatory requirements. For example, some regulations require that processing and authorization of funds transfer transactions run locally (e.g., because they are to be carried out from a certain jurisdiction).

The methods and systems described herein can be used with any sort of client, e.g., thin clients and fat clients. In some embodiments, the application functionality is divided between the data center and the client running in the user computer. Generally, any partitioning of functionality between the data center and the client can be used. Since in computer 24 the clients are isolated from one another and secured by the virtualization layer, high-functionality clients can be used without compromising data security or operation cost.

The configuration of FIG. 1 is an example configuration, which is chosen purely for the sake of conceptual clarity. In alternative embodiments, any other suitable configuration can also be used. For example, FIG. 1 shows a single user computer and two data centers. Alternatively, however, system 20 may comprise any desired number of user computers and any desired number of data centers, or even a single data center. In particular, CMS 68 typically manages a large number of user computers. A given user computer may run any desired number of VMs (OEs).

The description above refers mainly to isolation of software clients that interact with data centers. Alternatively, the methods and systems described herein can be used for isolating any other suitable OE running on the user computer, which may or may not involve communication with external entities. For example, a certain user computer may run one isolated OE for interacting with a data center, and another isolated OE that runs a local application. In FIG. 1, for example, VMs 52A and 52B interact with data centers, whereas VM 52C runs a local application. Such a local application may perform any suitable function, such as perform security tasks on the computer as a whole.

In some embodiments, virtualization layer 48 presents a unified Graphical User Interface (GUI) to the user for two or more of the OEs. When using this technique, the user may be unaware of the fact that his or her computer operates multiple OEs, some of which may run locally and some remotely. In an example embodiment, the virtualization layer periodically scans the frame buffer of the user computer, i.e., the memory that stores the image to be displayed to the user on display 60. The virtualization layer attempts to identify graphical patterns, symbols or other features that are common to multiple OEs. Using the detected common features, the virtualization layer merges the GUI of the different OEs and presents a unified graphical interface to the user. Any suitable pattern recognition or other image processing technique can be used for this purpose.

In some embodiments, computer 24 and/or CMS 68 comprise general-purpose computers, which are programmed in software to carry out the functions described herein. The software may be downloaded to the computers in electronic form, over a network, for example, or it may, alternatively or additionally, be provided and/or stored on tangible media, such as magnetic, optical, or electronic memory.

### Isolation Policies Enforced by Virtualization Layer

In some embodiments, virtualization layer 48 enforces a certain isolation policy on the different VMs that run in user computer 24. For example, an isolation policy may define groups of VMs that are permitted to interact (e.g., exchange data or use common resources) with one another.

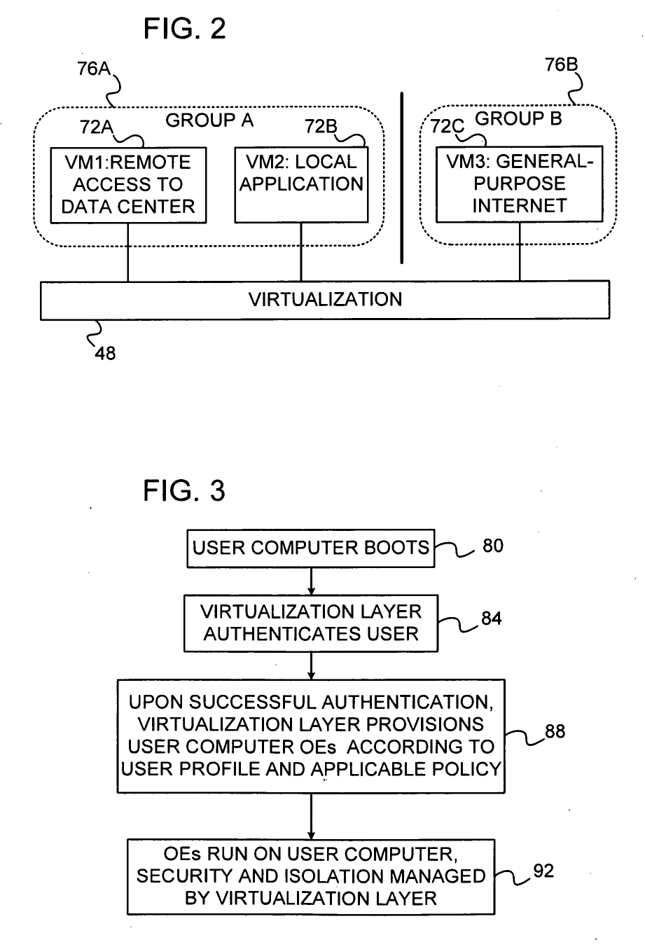

FIG. 2 is a diagram that schematically illustrates an example of an isolation policy enforced by virtualization layer 48, in accordance with an embodiment of the present invention. In the example of FIG. 2, the user computer runs three VMs 72A . . . 72C. VM 72A runs a client that performs remote access to a certain data center. VM 72B runs a certain local application. VM 72C runs a client that provides general-purpose Internet browsing or Instant Messaging (IM).

The isolation policy associates VMs 72A and 72B with a group 76A. VM 72C, on the other hand, is associated with a group 76B. Interaction between VMs is permitted only within each group and not between groups. Thus, this isolation policy allows VM 72A and 72B to interact with one another, but not with VM 72C. Virtualization layer 48 allocates hardware resources to VMs 72A . . . 72C in a manner that enforces this policy. The policy of FIG. 2 is shown purely by way of example. Any other suitable kind of isolation policy can also be used.

### User Computer Initialization Example

In some embodiments, virtualization layer 48 provisions the different OEs and policies during initialization of the user computer.

FIG. 3 is a flow chart that schematically illustrates an example method for operating user computer 24, in accordance with an embodiment of the present invention. The method begins with computer 24 starting-up, at a booting step 80. Virtualization layer 48 boots first and authenticates the user, at a user authentication step 84. In an embodiment, the virtualization layer initially provisions and executes a login client, which prompts the user to login and provide his or her security credentials (e.g., username and password). The boot process of the login client is typically fast, such as on the order of 3-5 seconds. The login client may run locally on the user computer or remotely on another computer, e.g., using VDI.

Upon successful authentication of the user, the virtualization layer provisions the different OEs that are to run on the user computer, at an OE provisioning step 88. Typically, the virtualization layer provisions the OEs based on a user profile and an applicable isolation policy, as described above. The user profile typically defines a set of applications and services, or even entire OEs, that this user is intended (or allowed) to use. The user profile may be fetched, for example, from CMS 68 or from any other suitable location. One or more of the OEs may be previously installed in the user computer. Additionally or alternatively, one or more of the OEs may be downloaded, e.g., from CMS 68, from a given data center or from any other suitable location.

Following provisioning of the OEs according to the isolation policy and user profile, the user computer runs the different OEs, at an operation step 92. OEs may run locally in the user computer and/or remotely in a data center, as described above. The virtualization layer typically redirects the user to one of the provisioned OEs. Layer 48 manages the isolation and security of the different OEs during operation.

The method of FIG. 3 refers to OE provisioning during initialization. Alternatively, however, the virtualization layer may provision OEs at any desired stage, e.g., during normal operation of the user computer.

The description herein refers mainly to hardware resources such as CPUs, memory devices and NICs. In addition, local services can be provided to support various other kinds of hardware resources, such as USB web cameras and other image capture devices and Disk-on-Key (DoK) devices. The virtualization layer may allocate such devices to specific VMs for performance or security reasons.

In some embodiments, certain client functions may be carried out by dedicated VMs. Such functions may comprise, for example, a local VoIP client, a local video streaming client and/or a local VPN client.

Although the embodiments described herein mainly address Information Technology (IT) and security applications, the methods and systems described herein can also be used in other applications, such as in consumer type services and applications, such as gaming.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method, comprising:
in a computer that runs multiple operating environments using hardware resources, defining and managing an allocation policy of the hardware resources, which eliminates effects from operations performed in one of the operating environments on the operations performed in another of the operating environments; and
assigning the hardware resources to the multiple operating environments in accordance with the allocation policy, so as to isolate the multiple operating environments from one another.

2. The method according to claim 1, and comprising running in one or more of the operating environments respective client programs for communicating with remote servers.

3. The method according to claim 2, wherein running the client programs comprises performing data processing functions locally in the computer by at least one of the client programs.

4. The method according to claim 3, wherein performing the data processing functions comprises performing multimedia processing functions locally in the computer.

5. The method according to claim 4, wherein performing the multimedia processing functions comprises performing at least one processing type selected from a group of types consisting of Voice over Internet Protocol (VoIP) processing and video streaming processing.

6. The method according to claim 2, wherein running the client programs comprises performing Virtual Private Network (VPN) processing functions locally in the computer by at least one of the client programs.

7. The method according to claim 2, wherein running the client programs comprises performing security functions locally in the computer by at least one of the client programs.

8. The method according to claim 2, wherein running the client programs comprises performing Internet browsing functions locally in the computer by at least one of the client programs.

9. The method according to claim 1, and comprising running in one or more of the operating environments respective applications that execute locally in the computer.

10. The method according to claim 1, and comprising running in one or more of the operating environments respective software appliances, each running a respective single-purpose application.

11. The method according to claim 1, and comprising communicating with a management system external to the computer, so as to enable the management system to apply authentication testing to the computer.

12. The method according to claim 1, wherein assigning the hardware resources comprises enforcing a predefined isolation policy on the operating environments.

13. The method according to claim 12, wherein enforcing the isolation policy comprises dividing the operating environments into groups, and allowing interaction among the operating environments only within each of the groups.

14. The method according to claim 13, wherein the isolation policy defines allowed sharing of data among the operating environments within each of the groups.

15. The method according to claim 1, and comprising provisioning a set of the operating environments for use by a given user responsively to a predefined profile of the given user.

16. The method according to claim 15, wherein provisioning the operating environments comprises retrieving one or more of the operating environments in the set over a network.

17. The method according to claim 15, wherein at least one of the operating environments in the set comprises a software appliance, which runs a single-purpose application.

18. The method according to claim 15, wherein provisioning the operating environments comprises authenticating the given user and provisioning the operating environments responsively to successful authentication.

19. The method according to claim 1, and comprising merging respective Graphical User Interfaces (GUIs) of two or more of the operating environments to produce a unified GUI, and presenting the unified GUI to a user of the computer.

20. The method according to claim 1, wherein the hardware resources comprise at least one resource type selected from a group of types consisting of processor resources, memory resources, network interface resources and peripheral devices.

21. A computer, comprising:
a memory, which is operative to store software code; and
a processor, which is configured to execute the software code so as to run multiple operating environments using hardware resources of the computer, to define and manage an allocation policy of the hardware resources, which eliminates effects from operations performed in one of the operating environments on the operations performed in another of the operating environments, and to assign the hardware resources to the multiple operating environments in accordance with the allocation policy, so as to isolate the multiple operating environments from one another.

22. The computer according to claim 21, wherein the processor is configured to run in one or more of the operating environments respective client programs for communicating with remote servers.

23. The computer according to claim 22, wherein the processor is configured to perform data processing functions locally by at least one of the client programs.

24. The computer according to claim 23, wherein the data processing functions comprise multimedia processing functions.

25. The computer according to claim 24, wherein the multimedia processing functions comprise at least one processing type selected from a group of types consisting of Voice over Internet Protocol (VoIP) processing and video streaming processing.

26. The computer according to claim 22, wherein the processor is configured to perform Virtual Private Network (VPN) processing functions locally by at least one of the client programs.

27. The computer according to claim 22, wherein the processor is configured to perform security functions locally by at least one of the client programs.

28. The computer according to claim 22, wherein the processor is configured to perform Internet browsing functions locally by at least one of the client programs.

29. The computer according to claim 21, wherein the processor is configured to run in one or more of the operating environments respective applications that execute locally in the computer.

30. The computer according to claim 21, wherein the processor is configured to run in one or more of the operating environments respective software appliances, each running a respective single-purpose application.

31. The computer according to claim 21, wherein the processor is configured to communicate with a management system external to the computer, so as to enable the management system to apply authentication testing to the computer.

32. The computer according to claim 21, wherein the processor is configured to enforce a predefined isolation policy on the operating environments.

33. The computer according to claim 32, wherein the processor is configured to enforce the isolation policy by dividing the operating environments into groups, and allowing interaction among the operating environments only within each of the groups.

34. The computer according to claim 33, wherein the isolation policy defines allowed sharing of data among the operating environments within each of the groups.

35. The computer according to claim 21, wherein the processor is configured to provision a set of the operating environments for use by a given user responsively to a predefined profile of the given user.

36. The computer according to claim 35, wherein the processor is configured to retrieve one or more of the operating environments in the set over a network.

37. The computer according to claim 35, wherein at least one of the operating environments in the set comprises a software appliance, which runs a single-purpose application.

38. The computer according to claim 35, wherein the processor is configured to authenticate the given user and to provision the operating environments responsively to successful authentication.

39. The computer according to claim 21, wherein the processor is configured to merge respective Graphical User Interfaces (GUIs) of two or more of the operating environments to produce a unified GUI, and to present the unified GUI to a user of the computer.

40. The computer according to claim 21, wherein the hardware resources comprise at least one resource type selected from a group of types consisting of processor resources, memory resources, network interface resources and peripheral devices.

41. A computer software product for operating a computer that includes hardware resources and runs multiple operating environments using the hardware resources, the product comprising a computer-readable medium, in which program instructions are stored, which instructions, when read by a processor, cause the processor to define and manage an allocation policy of the hardware resources, which eliminates effects from operations performed in one of the operating environments on the operations performed in another of the operating environments, and to assign the hardware resources to the multiple operating environments in accordance with the allocation policy, so as to isolate the multiple operating environments from one another.
